(19) United States
(12) Patent Application Publication
(10) Pub. No.: US 2011/0136428 A1
(43) Pub. Date: Jun. 9, 2011

(54) ENHANCED COMMUNICATION DEVICE HAVING TERRESTRIAL AND SATELLITE COMMUNICATION CAPABILITIES

(76) Inventor: Douglas Ritter, Gilbert, AZ (US)

(21) Appl. No.: 12/957,767

(22) Filed: Dec. 1, 2010

Related U.S. Application Data
(60) Provisional application No. 61/283,747, filed on Dec. 7, 2009.

(51) Int. Cl. H04B 7/185

(52) U.S. Cl. 455/13.4

(57) ABSTRACT

An enhanced communication device comprises a terrestrial wireless communication device and a satellite modem. The terrestrial wireless communication device may be used when terrestrial communications are permitted. Otherwise, messages may be generated at the terrestrial wireless communication device and transmitted to the satellite modem (such as through a wireless communications interface). The satellite modem may send the message via a satellite communication network or system. The satellite modem may also receive messages and provide them to the terrestrial wireless communication device for display.

### RELATED APPLICATION DATA

This application claims priority to U.S. Provisional Application Ser. No. 61/283,747, filed Dec. 7, 2009.

### FIELD OF THE INVENTION

The present invention relates to communication devices, including devices which communicate GPS position.

### BACKGROUND OF THE INVENTION

Various communication devices are known and each of them generally has a particular limitation. For example, terrestrial cellular phones are now very small and lightweight. However, the range of such phones is generally very limited. Thus, cellular phones can not be relied upon when travelling in remote areas.

Satellite phones have nearly global coverage. In order to transmit and receive signals to remote satellites, however, the phones are generally very large and heavy. They are also much more expensive to operate (owing generally to the cost of service, which is tied to the volume of use relative to the cost of the operation of the satellites). Thus, these phones are not favored for day to day use in most urban areas.

As a result of some of these limitations, some custom-configured communication devices have been developed. For example, the SPOT Satellite GPS Messenger includes a GPS receiver and is configured to send pre-designated messages and distress alerts via a satellite system. This device, however, is a specifically designed device. Thus, the device can be used for no other purpose. For example, the device can not be used for voice calls or text messaging. Another example is the Solara Field Tracker 2100, which includes a GPS and is configured to provide two-way satellite text messaging and remote tracking in a ruggedized case, but it is bulky, heavy and expensive due to the need to incorporate input and display means into the device. This device, however, is a specifically designed device. Thus, the device can be used for no other purpose. For example, the device can not be used for voice calls.

A need exists for a more versatile communication device.

### SUMMARY OF THE INVENTION

One aspect of the invention is an enhanced communications device comprising the combination of a terrestrial wireless communication device and a satellite modem. The terrestrial wireless communication device may be used when terrestrial communications are permitted. Otherwise, messages may be generated at the terrestrial wireless communication device and transmitted to the satellite modem (such as through a direct or wireless communications interface). The satellite modem may send the message via a satellite communications network or system. In one embodiment the satellite modem also includes a receive function, permitting the satellite messages to be received by the satellite modem. Those messages may be provided from the satellite modem to the terrestrial wireless communication device (via the communications interface) for display to a user.

Further objects, features, and advantages of the present invention over the prior art will become apparent from the detailed description of the drawings which follows, when considered with the attached figures.

### DESCRIPTION OF THE DRAWINGS

FIG. 1 illustrates an enhanced communication device in accordance with a first embodiment of the invention;

FIG. 2 illustrates an enhanced communication device in accordance with a second embodiment of the invention;

FIG. 3 illustrates an enhanced communication device in accordance with a third embodiment of the invention; and

FIG. 4 illustrates a housing or case of one embodiment of an enhanced communication device.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is an enhanced communication device (“ECD”) comprising a terrestrial wireless communication device (“TWCD”) combined with a message send and receive satellite modem/device (“SM”). The ECD permits terrestrial voice and data communications and satellite data communications. In addition, the ECD permits use of an existing wireless communication device, thus providing much greater flexibility, as detailed below.

In one embodiment, the ECD includes a terrestrial wireless communication device. Such a device may be configured to communicate via cellular (for example a 2G, 3G or 4G cellular wireless network), a WiFi or other wireless terrestrial-based network. The device may comprise a standard cellular smart phone, such as an iPhone, BlackBerry or Droid device. In particular, in a preferred embodiment, the TWCD is a standard commercially available device that was particularly designed and configured as a terrestrial wireless communication device.

Such a TWCD may include various features in its already configured format. As is well known, such a device generally includes its own housing, power supply (such as a rechargeable battery), video display, one or more buttons or a keypad, a touch screen and/or other user input or output devices. In one embodiment, the TWCD may include an internal or integrated GPS receiver for receiving global positioning satellite data.

In one embodiment, the SM is a short message service (SMS or text message) send and receive modem. This modem might comprise, for example, a satellite modem compatible with the Iridium or Globalstar satellite communications network(s).

In one embodiment, the TWCD and the SM are configured to communicate with one another. For example, the TWCD and the SM may communicate directly via a wired, and in one embodiment a wireless, link. For example, if the TWCD includes a Bluetooth communications module or interface, the SM may include such an interface (separate or integrated) as well, thus allowing wireless communications between the two devices. In another embodiment, the SM and TWCD may be coupled via a wired link such as a USB or via the TWCD's proprietary interface socket.

In one embodiment, the ECD includes other features. For example, the ECD may include a power source (for powering either or both of the SM and TWCD) such as one or more rechargeable batteries, an antennae (for enhancing the transmit and receive capacity of the SM), one or more user controls such as an on/off button, and a housing or case. The ECD may also include various computer executable program code or “software”. Such software might comprise, for example, an application executable by a processor of the TWCD to permit communications with the SM.

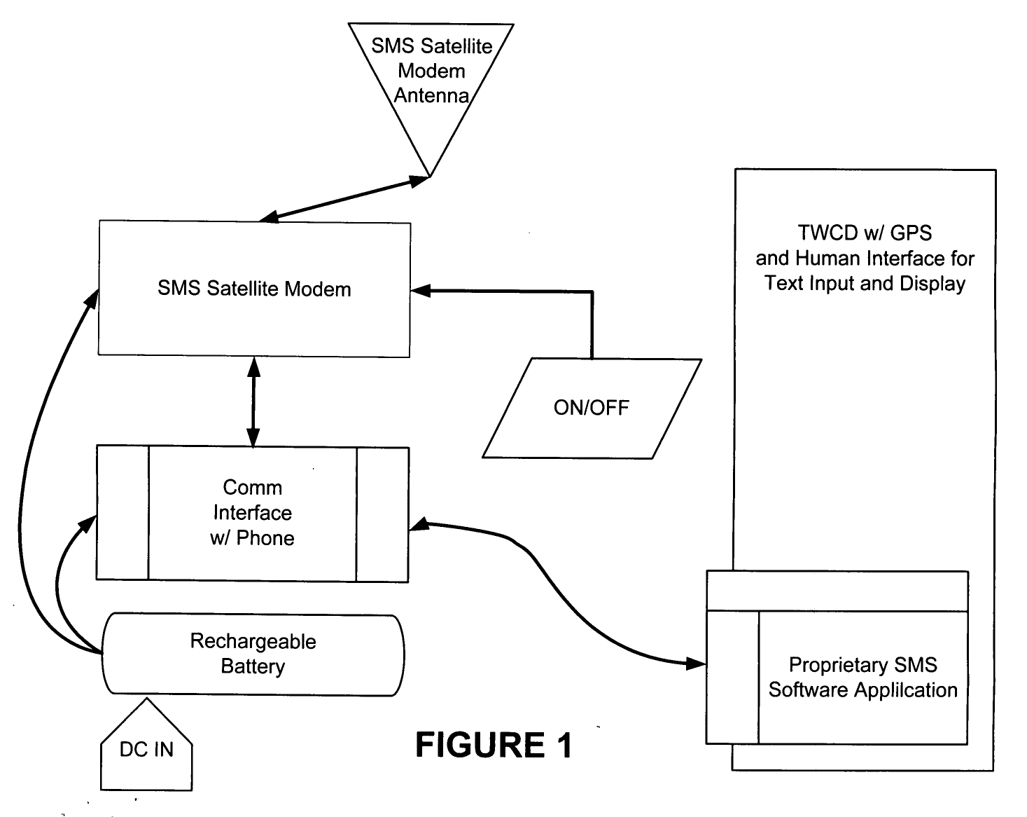

A first embodiment of an ECD is illustrated in FIG. 1. As illustrated, a SM is powered by a rechargeable battery. The SM is coupled to an antenna for send/receive functions. The SM may be turned on and off via a button. The SM communicates with a TWCD via a communications interface. As illustrated, the TWCD may include a software application.

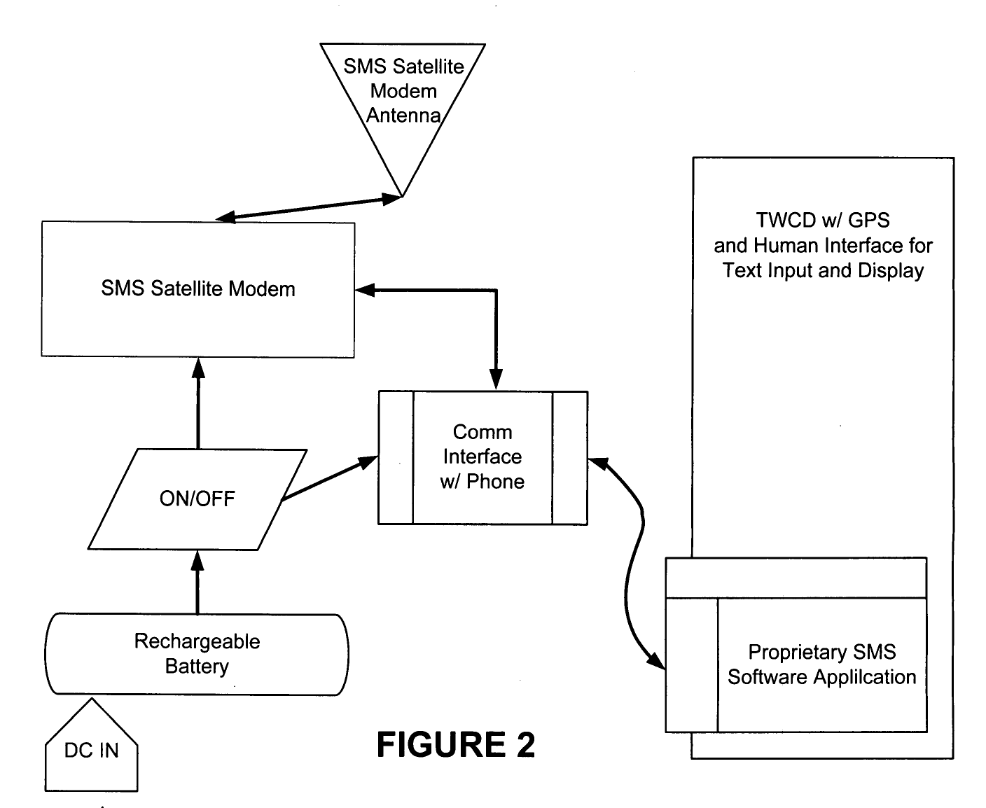

A second embodiment of an ECD is illustrated in FIG. 2. In this configuration, the on/off button controls power to both the SM and the communications interface.

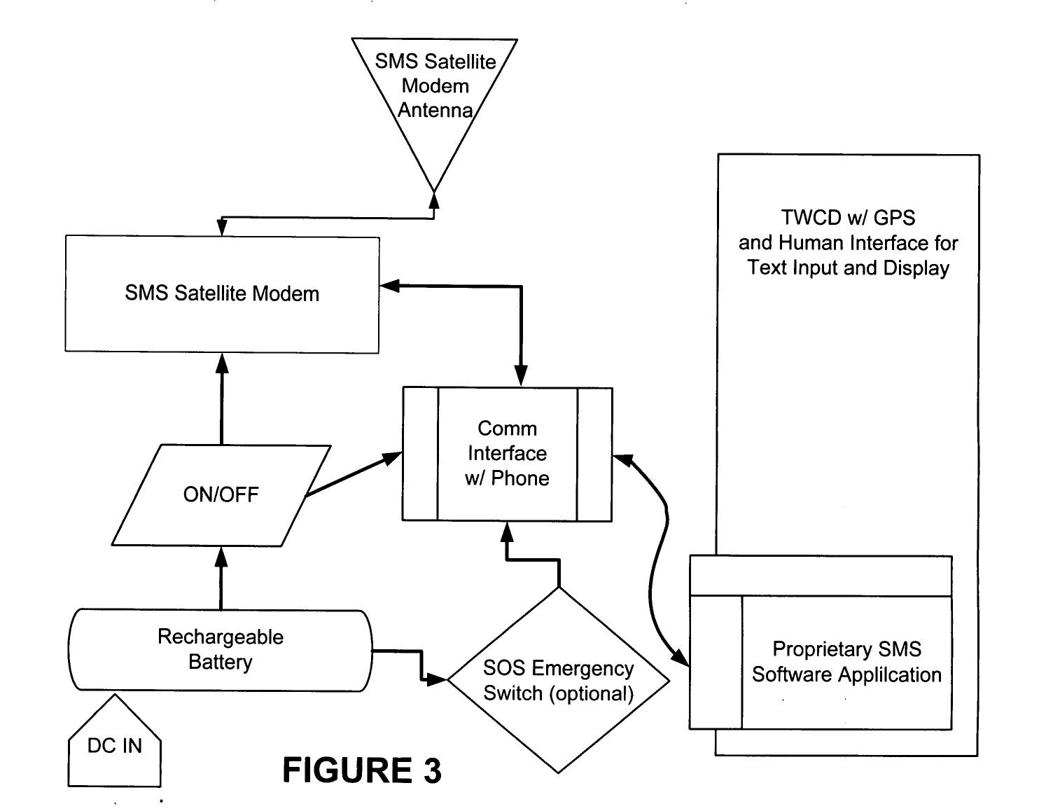

A third embodiment of an ECD is illustrated in FIG. 3. In this embodiment, the ECD includes an emergency or “SOS” switch or control. This switch or control may be used to cause an emergency communication to be generated and transmitted, as detailed below.

Additional aspects of the invention will become apparent from a description of the operation of the ECD.

First, a user may use the TWCD portion of the ECD as usual. Thus, if a user is in a location where terrestrial wireless communications are enabled, such communications may be performed solely through the TWCD.

However, in the event terrestrial communications are not permitted, communications are enabled via the satellite modem portion of the ECD. In one embodiment, such functionality may automatically be enabled (such as if the TWCD does not detect terrestrial communications coverage) or it might be manually enabled (such as by a displayed icon, menu feature or button of the TWCD). In such event, a user may send one or more SMS or text messages from their TWCD via the SM. In particular, a user may generate such a message at their TWCD, such as by using a keypad or display thereof to create a message or to generate and send an existing message (such as a stored emergency message). Such a message is transmitted from the TWCD to the SM via the communications interface. Once received by the SM, the message is transmitted to one or more satellites and then routed through an existing communication network coupled to those satellites to one or more intended recipients.

In one embodiment, the message may comprise or may include GPS data. Such data may be acquired by the GPS receiver of the TWCD.

As indicated, some of the functionality may be implemented via software or hardware at the TWCD. In a preferred embodiment, a software application is loaded into a memory of the TWCD and is executed at the TWCD, thus enabling the features described herein without having to alter the physical configuration of the TWCD. For example, the functionality may be implemented via an iPhone application loaded onto an existing iPhone device.

Such software might cause one or more icons or graphical user interfaces to be displayed, or cause certain buttons or combinations thereof of the TWCD to implement certain features of the ECD. For example, the software might cause a “send satellite message” icon to be displayed on a display of the TWCD. Upon selecting this icon, a graphical user interface might be displayed that includes options permitting a user to turn on or off the satellite messaging function, enter custom messages, select existing messages, send messages with or without GPS data or the like.

In one embodiment, the SOS or emergency switch of the device may cause the device to automatically send an emergency message via the satellite modem without input to the TWCD. Such a feature may be useful in an emergency situation where a user may not be able to provide detailed input to the TWCD or if the TWCD's interface was damaged.

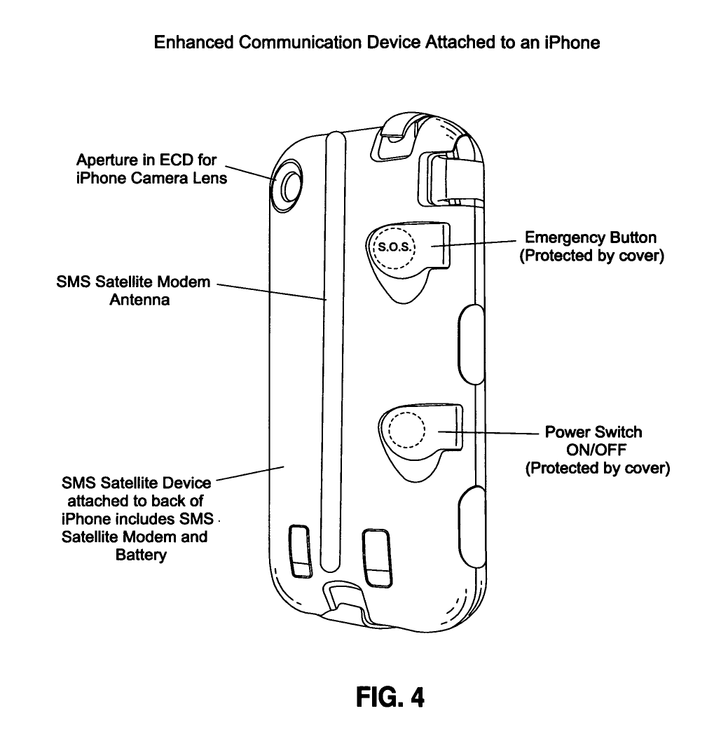

In a preferred embodiment, the ECD utilizes an existing TWCD. Thus, as one aspect of the invention, the ECD may comprise a housing that houses one or more components thereof and is configured to accept an existing TWCD. FIG. 4 illustrates one embodiment of an ECD which includes a housing or case. As illustrated, various components of the device, such as the SM and associated power source, may be located in an enclosed, protected area of the case. A power switch, SOS switch or other inputs/controls may be accessible at an exterior of the case. In one embodiment, the case or housing may include a recessed area or a separate enclosed/closeable interior area for housing a TWCD.

In accordance with the ECD, a user may use their TWCD separate from the other components of the ECD. For example, if a user is in an urban area where terrestrial wireless communications are sure to exist, they may carry only their TWCD. However, if the user may travel or does travel to an area where such communications may not exist, the user may associate their existing TWCD with the ECD, such as by placing it inside the housing/case. The user may still use the TWCD as normal, but in the event terrestrial communications are not possible, the user then has the option of sending messages via the SM.

The invention has numerous advantages. First, the device utilizes an existing TWCD reducing the cost and complexity of the device. In addition, by combining the two communications devices into a single manageable unit and eliminating duplication of components, the sum total is smaller, lighter and more convenient that two separate devices

In addition, while the ECD permits either terrestrial or satellite communications (thus overcoming traditional problems with terrestrial wireless communications devices), the TWCD can be separated from the rest of the device, so that it does not suffer from the problem of being too large and heavy (when only terrestrial communications are necessary).

The invention has particular use to those who travel, including pilots, boaters, hikers, military and government personnel, oil and mineral exploration and remote industry personnel and the like. Among other things, the ECD can be used as a way to seek emergency help. For example, in the event of an emergency the user has the option of using terrestrial communications (such as phone call or message) to family, friends or emergency personnel, or if such is not available, sending a satellite message. Such a message may include GPS data so that the user can easily be located. In one embodiment, such a device may be used with a monitoring system such as that used with the SPOT satellite messenger, wherein emergency messages are monitored and used to activate rescue personnel.

While the SM may only be configured with a transmit function or capability, the functionality of the device is greatly enhanced if the SM includes both send/transmit and receive functionality. For example, if the SM includes a receive function, third parties may send messages to the user via a satellite communication system via the user's SM. Such a message may be transmitted from the SM through the ECD's communications interface to the TWCD for display to the user. For example, a hiker caught in a storm might send a message to a friend to indicate that they found a shelter and don't need assistance and that friend might send a confirmation back.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. An enhanced communication device comprising in combination:
an existing terrestrial wireless communication device having a display and at least one user input device; and
a satellite communication device comprising:
a satellite messaging modem configured to send and receive satellite routed messages;
a power source for said modem; and
a communication interface between said wireless communication device and said satellite messaging modem, whereby a message generated at said wireless communication device may be received by said satellite messaging modem and transmitted therefrom as a satellite message and where a satellite message received by said satellite messaging modem may be provided to said wireless communications device for display to a user thereof via the display of said wireless communications device.

2. The combination in accordance with claim 1 further comprising a housing, wherein said housing has a first compartment housing at least said satellite modem and a second portion configured to receive said terrestrial wireless communication device.

3. The combination in accordance with claim 1 wherein said terrestrial wireless communication device further comprises a first housing having a front and a rear and said satellite communication device further comprises a second housing, said second housing detachably connected to said first housing and located at said rear of said first housing.

4. The combination in accordance with claim 1 wherein said communication interface comprises a wireless communication interface.

5. The combination in accordance with claim 4 wherein said wireless communication interface comprises a Bluetooth interface.

6. The combination in accordance with claim 1 wherein said satellite communication device further comprises a power switch for selectively controlling power from said power source to said modem.

7. The combination in accordance with claim 1 wherein said satellite routed messages comprise text messages.

8. The combination in accordance with claim 7 wherein said text messages comprise SMS messages.

9. The combination in accordance with claim 1 wherein said terrestrial wireless communication device further comprises a wireless transceiver.

10. The combination in accordance with claim 9 wherein said wireless transceiver is configured to communicate via a 2G, 3G and/or 4G wireless network.
